(19) United States
(12) Patent Application Publication
(10) Pub. No.: US 2021/0004675 A1
(43) Pub. Date: Jan. 7, 2021

(54) PREDICTIVE APPARATUS AND METHOD FOR PREDICTING WORKLOAD GROUP METRICS OF A WORKLOAD MANAGEMENT SYSTEM OF A DATABASE SYSTEM

(71) Applicant: Teradata US, Inc., San Diego, CA (US)

(72) Inventors: Bhashyam Ramesh, Secunderabad (IN); Naveen Thaliyil Sankaran, Hyderabad (IN); Lovlean Arora, Punjab (IN); Sourabh Maity, Howrah (IN); Jaiprakash G. Chimanchode, Hyderabad (IN); Douglas P. Brown, Rancho Santa Fe, CA (US)

(73) Assignee: Teradata US, Inc., San Diego, CA (US)

(21) Appl. No.: 16/729,809

(22) Filed: Dec. 30, 2019

Related U.S. Application Data
(60) Provisional application No. 62/869,901, filed on Jul. 2, 2019.

(51) Int. Cl. G06N 3/08; G06N 3/04; G06F 9/48

(52) U.S. Cl. CPC G06N 3/08; G06F 9/4843; G06N 3/04

(57) ABSTRACT

A method is provided for predicting workload group metrics of a workload management system of a database system. The method comprises predicting a future workload group metric for a plurality of workload groups based upon historical user-load patterns. Each workload group has a priority that is different from priority of other workload groups.

### TECHNICAL FIELD

The present disclosure relates to database systems, and is particularly directed to a predictive apparatus and method for predicting workload group metrics of a workload management system of a database system.

### BACKGROUND

A database of a database system is a collection of stored data that is logically related and that is accessible by one or more users or applications. A popular type of database is the relational database, which includes relational tables, also referred to as relations, made up of rows and columns (also referred to as tuples and attributes). Each row represents an occurrence of an entity defined by a table, with an entity being a person, place, thing, or other object about which the table contains information.

Modern database systems execute a variety of query requests concurrently and operate in a dynamic environment of cooperative systems, each comprising of numerous hardware components subject to failure or degradation. The need to regulate concurrent hardware and software “events” has led to the development of a field which may be generically termed “Workload Management”.

Workload management techniques focus on managing or regulating a multitude of individual yet concurrent requests in a database system by effectively controlling resource usage within the database system. Resources may include any component of the database system, such as CPU (central processing unit) consumption, disk TO (input/output) consumption, or hard disk or other storage means consumption. Workload management techniques fall short of implementing a full system regulation, as they do not manage unforeseen impacts, such as unplanned situations (e.g., a request volume surge, the exhaustion of shared resources, or external conditions like component outages) or even planned situations (e.g., systems maintenance or data load).

Contemporary workload management systems allow users to establish service level goals (SLGs) for workloads. The SLGs are primarily used for reporting purposes (e.g., to gauge the success of the workload's performance and to note trends with respect to meeting those SLGs). One example option is to establish an SLG based on response time with a service percentage. Another example option is to define the SLG based on throughput rate (i.e., completions).

Another use of the SLGs is to automatically detect when SLGs are being missed. For example, one of the primary approaches used by database administrators (DBAs) and system administrators is to first identify that there is a problem with their SLGs. Investigations into why will typically start with analysis at the system-level. If the system is not 100% busy and does not have heavy skewing, then typically the DBA will next check for blocked sessions.

However, if the CPU is 100% busy, then the number of active sessions will be checked for unusually high concurrency levels. If some workloads have too many active sessions, then appropriate actions may be taken, such as to limit concurrency, to abort queries, and/or to make adjustments to Priority Scheduler weights. If the CPU is 100% busy and active sessions appear appropriate, the DBA may next check the CPU consumption by workload and/or session to evaluate if there is a runaway query. From here, the DBA may take the appropriate action (e.g., to abort the offending request). These investigations are triggered based on knowing that SLGs are being missed, enabling the DBA to act to resolve the situation, and bring workload performance back to SLG conformance.

There are a number of different resources which can be monitored for effective parallel usage across a database system. The different resources include CPU consumption, disk IO consumption, memory consumption, and network consumption, for example. The resources usually require careful management because system performance and active requests are affected when these resources are depleted. Such careful management is laborious and time consuming for the DBA. Accordingly, those skilled in the art continue with research and development efforts in the field of workload management systems of database systems.

### SUMMARY

In accordance with an embodiment, a method is provided for predicting workload group metrics of a workload management system of a database system. The method comprises predicting a future workload group metric for a plurality of workload groups based upon historical user-load patterns. Each workload group has a priority that is different from priority of other workload groups.

In accordance with another embodiment, a method is provided for predicting workload group metrics of a workload management system of a database system. The method comprises extracting feature values associated with operation of the database system. The feature values comprise at least one of central processing unit (CPU) consumption, input/output (TO) consumption, and query arrival rate. The method also comprises reducing the number extracted feature values by removing correlated feature values and skewed feature values. The method further comprises predicting the workload group metrics based upon the reduced number of extracted feature values.

In accordance with yet another embodiment, a method is provided for operating a workload management system of a database system. The method comprises predicting a workload group metric value, and obtaining from query logs an actual value of the corresponding workload group metric value. The method also comprises computing a difference between the predicted value and the actual value. The method further comprises performing at least one of alerting a user and initiating auto-training of a workload when the difference between the predicted value and the actual value is more than a threshold value.

### BRIEF DESCRIPTION OF THE DRAWINGS

FIG. 1 is a block diagram of a predictive apparatus for predicting workload group metrics of a workload management system of a database system.

FIG. 2 is a table depicting priority of workload group tiers used in the workload management system shown in FIG. 1.

FIG. 3 is a block diagram of an example architecture of the predictive apparatus shown in FIG. 1, and constructed in accordance with an embodiment.

FIGS. 4A, 4B, and 4C are plots showing encoding of hours of days.

FIG. 5 is a flow diagram depicting an example method performed by the predictive apparatus of FIG. 3 in accordance with an embodiment.

FIG. 6 is a flow diagram depicting another example method performed by the predictive apparatus of FIG. 3 in accordance with an embodiment.

FIG. 7 is a flow diagram depicting yet another example method performed by the predictive apparatus of FIG. 3 in accordance with an embodiment.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

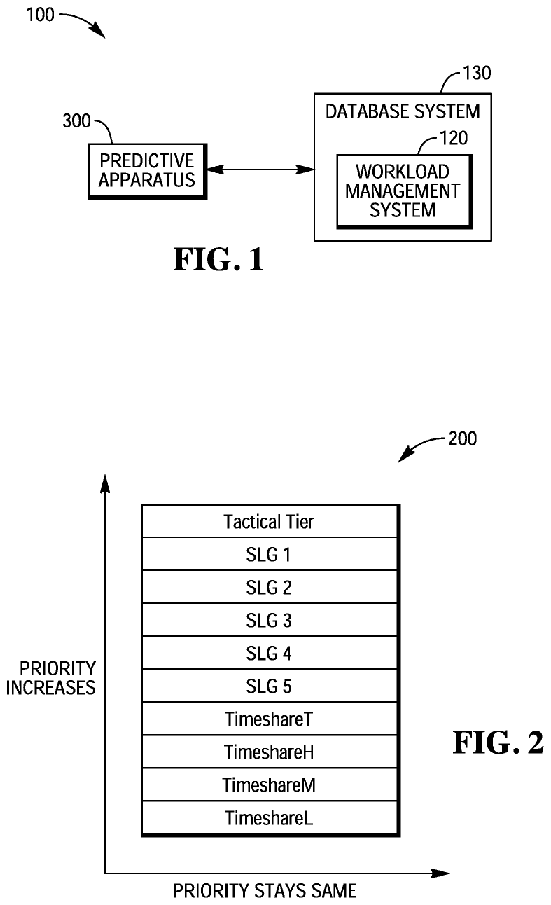

Referring to FIG. 1, a block diagram 100 of a predictive apparatus 300 for predicting workload group metrics of a workload management system 120 of a large database system 130 is illustrated. The database system 130 may comprise a Teradata Active Data Warehousing System, which is commercially available from Teradata Corporation located in San Diego, CA. The database system 130 includes a relational database built upon a massively parallel processing (MPP) system. Other types of database systems, such as object-relational database systems or those built on symmetric multi-processing (SMP) platforms, are also suited for use. The depicted and described database system 130 is exemplary only and is chosen to facilitate an understanding of the disclosed embodiments.

The workload management system 120 of the database system 130 may comprise a Teradata Active System Management (TASM), which is also commercially available from Teradata Corporation. Other types of workload management systems are also suited for use. The depicted and described workload management system 120 is exemplary only and is chosen to facilitate an understanding of the disclosed embodiments.

The workload management system 120 comprises the following three items that are specified by a user during a setup process for the workload management system 120:
1) Classification rules to define workload: Among all incoming queries, there can be many sub-groups of queries having some commonality among them. This might be due to nature of queries or due to any business rules. User must set up rules to identify and map these subgroups into different workload groups. This helps user to manage and control queries easily. There are multiple ways in which user can create workload classification rules like source of query (e.g., sales team), query characteristics (number of joins, etc.) or query target (specific tables, etc.).
2) Priority of defined workloads: User must set the priority of each of the workload groups. The basic need for assigning different priorities can be explained by the following intuition. In case of TASM and with reference to FIG. 2 which shows a priority table 200, a user must place the defined workload groups into either of the following tiers (in descending order of priority), Tactical, SLG1, SLG2, SLG3, SLG4, SLG5, TimeShareT, TimeShareH, TimeShareM, TimeShareL. For example, the Tactical queries will be given higher access to priority than the decision support system (DSS) queries in Timeshare. Tactical tier is for very high priority workloads that are highly tuned. Service level goal (SLG) tiers are used for workloads supporting high priority queries with SLGs, and Timeshare tiers are used for standard or background workloads like data load. Multiple workloads can be assigned to same tier and workloads within same tier have the same priority.
3) Allocate relative share of resources (RelShare) and SLG for the workloads: Each workload group may have different resource demand and SLG expectations. The basic need for assigning different RelShare and SLG can be explained by the following intuition. The tactical queries will consume less CPU, will have less elapsed time and quicker service level goal than the queries that are intended for some complex data analysis. A user must specify the relative percentage of resources allocated to each workload group. For TASM, the resources a user considers are CPU share percentages and IO share percentages.

The priority tiers shown in FIG. 2 function in a waterfall model, wherein the bottom tiers get leftover resources from the tiers above it. For example, assume tier 1 is allocated 70% resources and tier 2, which is below tier 1, is allocated 50% resources. This means that tier 2 gets 50% of leftover resources from tier 1 (i.e., 50% of (100-70) %=15% system resource). If this allocation is not done carefully, this may lead to starvation in lower tiers and can lead to SLG slippage by workloads present in lower tiers. Presently, DBAs set resource allocation for workloads based on historical observations of the load pattern for the workload. However, the process is mostly heuristic-based in nature and multiple trial and errors are required before the DBA can identify an ideal resource share allocation for workloads.

In accordance an aspect of the present disclosure, the predictive apparatus 300 is provided to predict workload group metrics of the workload management system 120. The following metrics for each workload group are predicted per timestep:
1) Percentage of total CPU that a workload group is going to consume in a specified timestep.
2) Amount of IO in kilobytes (KB) that a workload group is going to consume in the specified timestep.
3) Number of queries which are going to arrive for a workload group in the specified timestep.

In the example disclosed embodiment, the CPU consumption in percentage, the IO consumed in KB, and the query arrival rate for a given workload are predicted. By predicting the above-described workload group metrics, the system capacity can be dynamically scaled up or scaled down depending on the system load. Also, resources to workload groups can be dynamically allocated such that overall system performance is optimized.

More specifically, the workload group metrics are predicted by modeling its users' workloads from history and learning history patterns of user loads. The term “timestep” used herein represents an “interval of time” (e.g., an hour, 10 minutes, etc.). The value of the time interval should not be too small or too granular since the resources consumed by queries/workload groups are being predicted. Also, the time interval should not be too long because target values could be averaged out to be same at every prediction point. Accordingly, for example, a time interval no less than 10 minutes and no greater than 180 minutes is recommended. A time interval shorter than 10 minutes or a time interval longer than 180 minutes is possible.

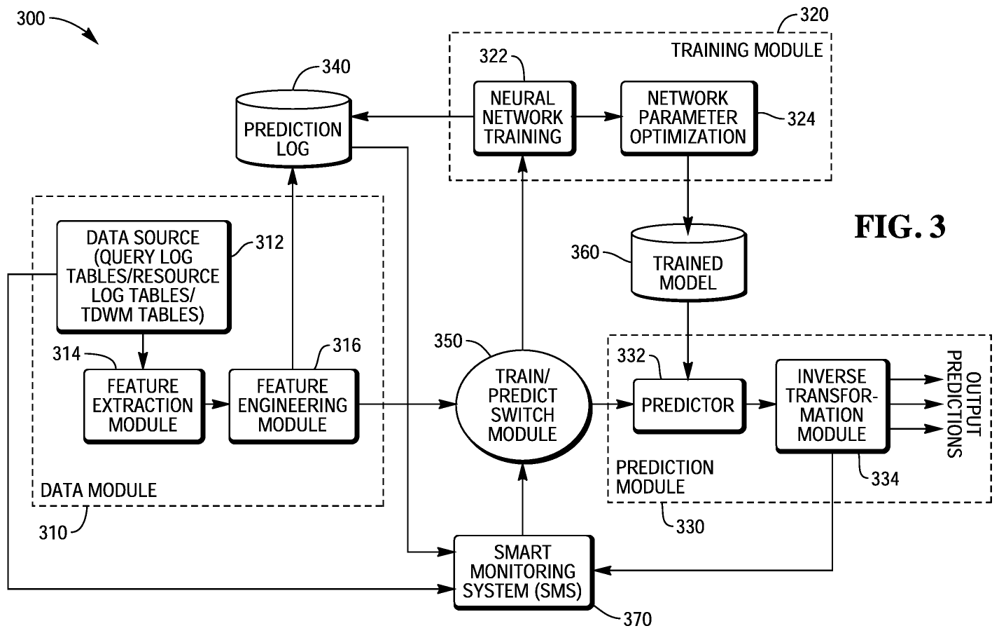

Referring to FIG. 3, the predictive apparatus 300 comprises three modules including a data module 310, a training module 320, and a prediction module 330. The data module 310 is responsible for extracting data from data sources 312 of the database. As shown in FIG. 3, the data sources 312 include the following:

1) Query Log Tables: These tables have information regarding query arrival rates, which workload does it belong to, how much was query elapsed time and was it meeting its SLG.

2) Resource Log Tables: Different resource usage parameters per workload from these tables are extracted. Some of the parameters extracted include CPU utilization, TO consumption, worker thread (AWTs) consumption, etc.

3) Teradata workload Management (TDWM) tables: TASM definitions present in TDWM tables are used to identify the workload groups, the tier which the workload groups belong to, their priority, relative resource share for the workload groups and their SLGs.

The data module 310 includes a feature extraction module 314 that extracts features from the dataset. Since it is desired to predict CPU, TO, and query arrival rate for each workload, all such features which directly or indirectly impact them are extracted. Keeping this in mind, the below mentioned example of 46 features for each workload may be extracted:

### 1) CPU Related Features (2 Features)

CPU consumed, CPU wait.

Since it is desired to allocate resource share for CPU, how much CPU will be consumed is predicted. CPU consumed is represented as percentage of total CPU available in the entire system.

A CPU wait captures how much was scarcity for the CPU and hence captures total CPU demand. This CPU demand is needed for dynamically scaling and descaling system capacity.

### 2) IO Related Features (10 Features)

Logical IO submitted and completed is represented as total number of IO requests (IO count), total IO requested in KB, and average KB per IO request. Three representations are used to distinguish between multiple IO requests each demanding very small IO vs. single IO request demanding large amount of IO.

Physical IO in count, in KB, in average KB per IO, and IO wait in milliseconds.

Logical IO captures total IO demand. Some IO requests may be fulfilled via cache and queries need not actually do physical IO. So, both physical and logical IO are captured. The difference between logical and physical IO is that logical IO captures cache effect and hence indirectly measures the effect of concurrency in queries (more the concurrency, more the cache purging, more the difference between physical and logical IO).

### 3) Arrival Rate Metrics (ARM) Related Features (2 Features)

Number of queries arrived and number of queries which completed the execution.

These together capture complexity of queries along with how many queries are spilled over to next hour and thereby impacting load in next hour.

### 4) Worker Thread (AWT) Related Features (25 Features)

There are 6 worker thread classes, namely New, Spawn, Utilities, Expedited, Abort, and Misc. From each of these worker thread classes, there are 3 extracted features: InUse, Max, Exhausted, giving a total 18 features.

Total InUse, Exhausted and Max across all 6 classes which are mentioned above are also extracted. (total of 3 features)

Worker threads Assigned, Released, wait time, and average wait time. (total of 4 features)

A query uses many worker threads as it comprises many steps. Also, the steps in a query can be running in parallel. These numbers capture how many worker threads are being used (InUse) in whole system, what is the maximum number of worker threads used (Max), how many times there was shortage for worker threads (Exhausted), and for how long this shortage lasted (AWT wait time). These capture the effect of complexity (less queries and more worker threads imply complex queries) and concurrency in the system.

### 5) Lock Wait (3 Features)

Data block lock, lock for memory segments aggregated into single feature. This is then expressed as total number of locks requested (lock count), lock time millisecond and average wait time in millisecond per lock wait. These features capture concurrency, especially if queries/steps are fighting for same resources.

### 6) Other Wait Time (3 Features)

All other waits (monitor wait, flow control, etc.) are aggregated into single feature and is represented as total number of lock requested (lock count), in millisecond and in average wait time in millisecond per wait. These features capture concurrency especially if queries/steps are fighting for same resources.

### 7) Number of Active Sessions (1 Feature)

More number of active sessions indicate more number of concurrent queries.

As already discussed, tiers behave in waterfall model with respect to resources (i.e., the left-over resources from top tier are passed to lower tiers). Tactical queries have privilege of using whatever resources they want. For the workload groups in other tiers, TASM allocates resources per workload to control how much maximum resources they can consume in a heavily loaded system from whatever is left over from upper tiers. So, a workload consumes resources, which is a function of what it demands, what is allocated to it, what resources are consumed by higher tier queries, and what is left for it to use.

Hence, the feature vector for each workload should have features from all other workloads as well. However, this could lead issues in case new workloads are added to system or if existing workloads are deleted/deactivated or if workload priority changes. In such cases, the workload models have to be retrained to adjust to changed environment as feature vector length will change. An easy way to resolve this issue is to group workloads into bins. This will ensure that the feature length is constant and the effect of adding/removing workloads will be smoothed out.

Hence, for each workload under consideration (i.e., for the workload for which resource consumption parameters are being predicted, there will be a feature vector that finds same features for four bins as mentioned below:

1) Workload under consideration (denoted by WD (e.g., CPU LOAD MSEC WD denotes total CPU load in milliseconds for workload under consideration)).

2) All workloads having higher priority than workload under consideration (denoted by HP).

3) All workloads having lower priority than workload under consideration (denoted by LP).

4) All workloads which belong to same tier (siblings) as that of workload under consideration (denoted by SP).

This increases the total number of features from 46 to 184 (=46*4), for example. Additional features which denote day of week (numbered 1-7) and hour of day (numbered 0-23) is used to capture patterns which are specific to day of week (weekday vs. weekend) or time of day (morning vs. night). These are required to capture patterns specific to days (e.g., weekend load vs. weekday load) and time (e.g., night vs. day time load). This brings a final feature count to 186 as an example number. For day of the week feature, value 1 is assigned to the first working day of the week (and not Monday/Sunday specifically) as different regions in world can have different days as start of week.

It should be noted that the four bins mentioned above may not be applicable for all workloads (e.g., Tactical workloads will not have any workloads having more priority than them). So, bin 2 features are not required for them. Similarly, some workloads may not have any sibling workloads (bin 4) and hence those features will not be used. So, different workloads will have different number of total features extracted.

The data module 310 further includes a feature engineering module 316 that is responsible for trimming down the number of features. There are a number of steps involved in reducing feature dimension. These are listed below:

1) Remove correlated features: If two features are observed as being heavily correlated, only one of the features is kept. For the example embodiment described herein, a correlation coefficient ρ>0.95 is used to denote heavily correlated features. An example of such removal is: EXH TOTAL WD⇔[‘EXH NEW WD’, ‘EXH SPAWN WD’]. That is, the total number of worker threads (AWT) which were exhausted is correlated to AWT exhausted for NEW type requests and SPAWN type requests. So, only EXH TOTAL WD is kept and other two features are removed. This helps to reduce the number of features to around 100, for example.

2) Skew removal: A feature is said to be having skewed distribution if its skewness factor is less than −1 or greater than +1. In such cases, a cube-root transformation is applied to remove the skew.

3) The feature values are standardized by removing the mean and scaling it to unit variance. This is especially useful for regression using neural networks. For the example embodiment described herein, Min-Max Scaling is selected for feature normalization.

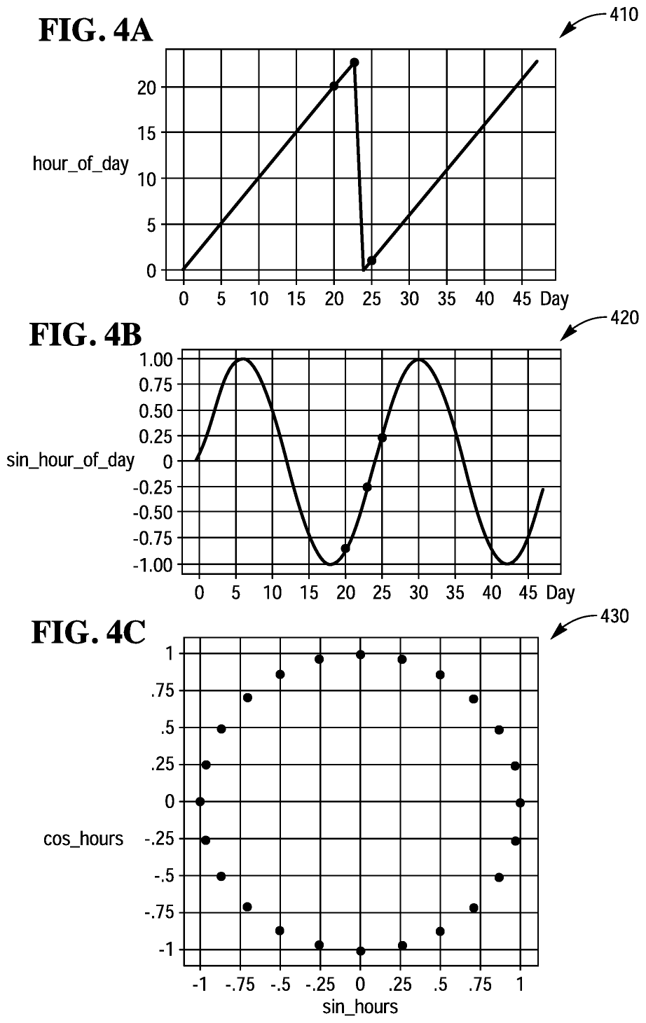

4) Encoding Cyclical features: Features like hour of day present different challenge during normalization as they are cyclic in nature (i.e., after 23 hours, the next value is 00 and not 24). This is shown in plot 410 of FIG. 4A in which even though hour 23 of day 1 and hour 01 of day 2 are actually closer (difference of 2 hours), when represented as raw values, they look much further apart. Hence, the hour value is encoded using the following formula:

sin (encoded hour of day)=sin (2*π*hour of day/24)

Using the above encoding formula, sin(20)=−0.86; sin(23)=−0.25; and sin(01)=0.25. This ensures that hours 23 and 01 are more closer than hours 20 and 23. This is shown in plot 420 of FIG. 4B. However, the above sine encoding too has some issues as sin(02)=sin(10)=0.5. So, an additional cosine encoding for hour of day feature is used, thereby using two features to represent a single hour in a day. Cosine encoding is done using the following formula:

cos (encoded hour of day)=cos (2*π*hour of day/24)

Plot 430 of FIG. 4C shows how hours in a day will be after they are encoded using both sine and cosine encoding.

5) The present example set of ˜100 skew-corrected and normalized features need to be reduced further down to a more reasonable number. For this, Principal Component Analysis (PCA) may be used to reduce the feature from ˜100 to around 15, as an example number. During PCA, only those features which cumulatively retain ˜99% of variance are picked up. Results of the feature engineering module 316 are stored in a prediction log 340.

The predictive apparatus 300 also comprises a training module 320 including a neural network training component 322 and a network parameter optimization component 324. A train/predict switch module 350 is provided to allow operation of predictive apparatus 300 to be switched between the training module 320 and the prediction module 330. As mentioned, the CPU consumption in percentage, the IO consumed in KB, and the query arrival rate for a given workload are being predicted. For this purpose, a single neural network model is built per workload to predict these values. One model per workload is used rather than a single model for the entire system because of the following reasons:
1) Each workload can have different data distribution and different number of features, and hence has to be modelled individually.
2) In case the data pattern has changed over time for a workload, the corresponding model can be retrained while other workloads continue to function as usual.
3) Handling addition/deletion of workloads would be easier.

The input in the present disclosure is a sequence of data points ordered by time. What happened during last hours will influence what will happen in future. Queries which had been running in previous hour but have not yet completed can affect resource consumption for current hour. There can also be patterns which gets repeated like light load during an hour just before a business opens in morning or light load during lunch time etc. Hence, recurrent neural networks (RNNs) are used, as such networks are known to work well with time-series data. For the example disclosed embodiment, a specific form of RNN known as Long Short Term Network (LSTM) is used. This is because LSTMs are known to handle issues related to Vanishing Gradient very well. These are only example types of neural networks for the single neural network model. Other types of neural networks can be used.

Another point to consider while building the model is how much history should be provided to the model so that it can predict the future. For this, Auto Correlation Function (ACF) is used to plot to identify how much history is ideally needed to predict the future value. An ACF plot indicates the lag value with autocorrelation as it is the similarity between observations as a function of the time lag between them. As an example, the lag value may be five for the maximum correlation value. In this case, at least the last five values are taken to predict the future value. In the present disclosure, not only is a prediction for the next hour needed, but predictions for multiple future hours may also be needed. As an example, 10 previous history points may be used to predict the future value. The ACF is only an example method that can be used to provide the amount of history needed to predict the future value. Alternatively, or in addition to, other methods (such as trial and error based methods) may be used to provide the amount of history needed to predict the future value.

As mentioned, an LSTM model is used for the predictive apparatus 300 of the present disclosure. As an example, a single hidden layer with 150 hidden LSTM units may be used based on trying multiple network configurations and selecting the best performing configuration. There can be around 100,000 trainable parameters present in the model, various known optimization strategies may be employed, and various techniques may be employed to finish training quickly. A trained model 360 is saved locally for prediction. Availability and application of machine learning platforms including neural network models are known and, therefore, will not be described.

The predictive apparatus 300 further includes a prediction module 330 having a predictor 332 that scales features, and an inverse feature transformation module 334 that converts the scaled features into actual values.

During an example prediction, features for past 10 hours are extracted and then passed through the feature engineering module 316 as mentioned above. The extracted features are then sent to the trained model 360 to predict workload parameters for future 9 hours. The inverse feature transformation module 334 is applied on the generated outputs to convert the scaled features into actual values. For PCA, converting the output dimension to its original dimension will result in some loss of accuracy, but this is within acceptable limits.

As an example, a sliding window approach with step size of one may be used for prediction as follows:
To predict the immediate future hour (N+1), the previous 10 values (i.e., N−9, N−8, . . . , N−1, N) are used.
To predict N+3 hour, the N−7, N−6, . . . , N+1, N+2 are used as input where N+1 and N+2 are predicted values while other points (N−7 . . . N) are actual values.

The predictive apparatus 300 further includes a smart monitoring system (SMS) 370. One challenge with continuous prediction is that the underlying data distribution upon which the prediction is performed may change over time. Hence, the SMS 370 is used to monitor predictions and compare them with actual values for any deviations. The predicted values are logged in an internal log table, and the actual values are obtained from database.

As an example, assume the model has predicted that in the next hour, CPU consumed by a workload will increase by 20%. After next hour, the SMS 370 extracts logs for the workload from database and realizes that the CPU consumption has increased only by 5%. This means that the prediction was off for the workload. If the difference between predicted values and actual values increase over a certain threshold, the SMS 370 can either inform the user regarding the same or else it can initiate auto-retraining of the workload under consideration using the train/predict switch module 350.

The above-described predictive apparatus 300 is not only capable of predicting the future parameters for next one hour, but is also capable of predicting future parameters for future ‘n’ hours. For example, workload parameters for nine future hours can be predicted by using 10 previous observations as inputs. Also, while the focus has been on only three workload parameters (CPU, IO, and arrival rate), if it is desired to do prediction for a second hour (tᵢ+2), then predicted values for all input parameters are needed. These predicted values along with 9 other actual values (observations) from history are needed to perform prediction-on-prediction (rollover prediction). This means is that if the current time is tᵢ and it is desired to predict the parameters three hours from now (i.e., tᵢ+3) using 10 previous history points, the following should be provided as input:
1) Predicted outputs for two hours (tᵢ+1, tᵢ+2).
2) Real values for 8 hours (tᵢ−7 . . . tᵢ), since 10 previous points are needed to predict for 11^{th} point.

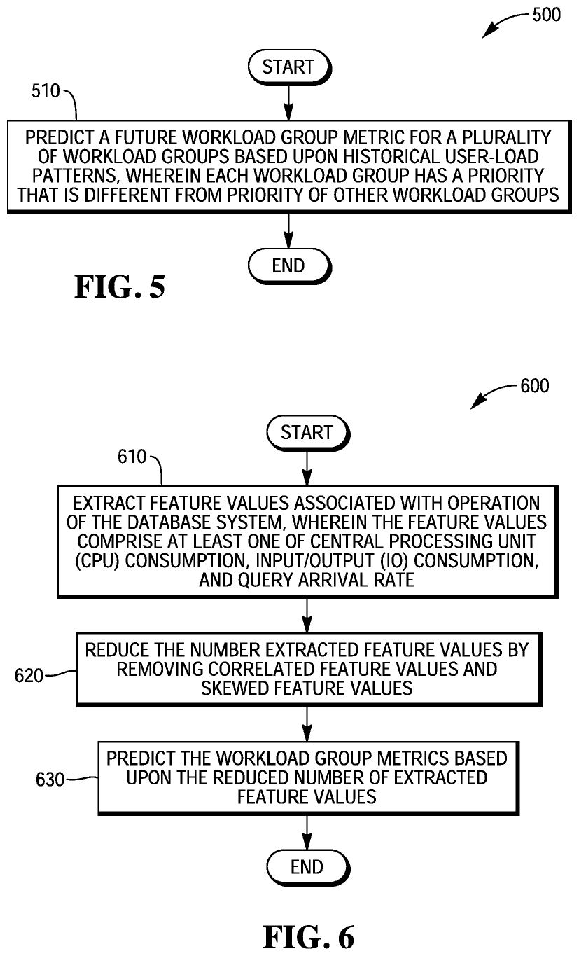

Referring to FIG. 5, a flow diagram 500 depicts an example method performed by the predictive apparatus 300 of FIG. 3 in accordance with an embodiment. In block 510, a future workload group metric is predicted for a plurality of workload groups based upon historical user-load patterns. Each workload group has a priority that is different from priority of other workload groups. The process then ends.

In some embodiments, a future processing unit (CPU) consumption for each workload group based upon historical user-load patterns, a future input/output (TO) consumption for each workload group based upon historical user-load patterns, and a future number of queries to arrive for each workload group based upon historical user-load patterns are predicted.

In some embodiments, a future workload group metric for each workload group based upon an encoded historical time interval that is between 10 minutes and 180 minutes is predicted.

In some embodiments, the method in the flow diagram 500 of FIG. 5 is performed by a processor having a memory executing one or more programs of instructions which are tangibly embodied in a program storage medium readable by the processor.

In some embodiments, a workload management system has a workload management task that uses the method in the flow diagram 500 of FIG. 5.

Referring to FIG. 6, a flow diagram 600 depicts another example method performed by the predictive apparatus of FIG. 3 in accordance with an embodiment. In block 610, feature values associated with operation of the database system are extracted. The feature values comprise at least one of central processing unit (CPU) consumption, input/output (TO) consumption, and query arrival rate. The process proceeds to block 520 in which the number extracted feature values is reduced by removing correlated feature values and skewed feature values. Then in block 630, the workload group metrics are predicted based upon the reduced number of extracted feature values. The process then ends.

In some embodiments, each feature value is normalized by (i) calculating a mean value, (ii) scaling the mean value to a unit variance, and (iii) removing the mean value.

In some embodiments, remaining feature values that cumulatively retain about 99 percent of variance are selectively picked.

In some embodiments, a single neural network model for each workload group is defined.

In some embodiments, one workload group is retrained based upon its corresponding single neural network model while other workload groups remain the same.

In some embodiments, the one workload group is retrained based upon a recurrent neural network model.

In some embodiments, the one workload group is retrained based upon a long short term neural network model.

In some embodiments, a neural network model is built based upon an auto-correlation function (ACF) to identify the amount history needed to predict a future feature value for a workload group.

In some embodiments, the method in the flow diagram 600 of FIG. 6 is performed by a processor having a memory executing one or more programs of instructions which are tangibly embodied in a program storage medium readable by the processor.

In some embodiments, a workload management system has a workload management task that uses the method in the flow diagram 600 of FIG. 6.

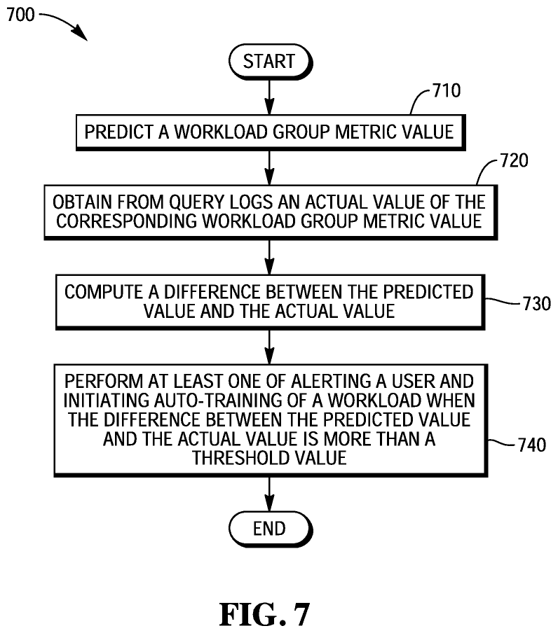

Referring to FIG. 7, a flow diagram 700 depicts yet another example method performed by the predictive apparatus of FIG. 3 in accordance with an embodiment. In block 710, a workload group metric value is predicted. The process proceeds to block 720 in which an actual value of the corresponding workload group metric value is obtained from query logs. The process proceeds to block 730 in which a difference between the predicted value and the actual value is computed. Then in block 740, at least one of alerting a user and initiating auto-training of a workload is performed when the difference between the predicted value and the actual value is more than a threshold value. The process then ends.

In some embodiments, the predicted workload group metric value comprises (i) a future central processing unit (CPU) consumption for each workload group based upon historical user-load patterns, (ii) a future input/output (IO) consumption for each workload group based upon historical user-load patterns, and (iii) a future number of queries to arrive for each workload group based upon historical user-load patterns.

In some embodiments, the predicted workload group metric value comprises a future workload group metric for each workload group based upon an encoded historical time interval that is between 10 minutes and 180 minutes.

In some embodiments, the method in the flow diagram 700 of FIG. 7 is performed by a processor having a memory executing one or more programs of instructions which are tangibly embodied in a program storage medium readable by the processor.

In some embodiments, a workload management system has a workload management task that uses the method in the flow diagram 700 of FIG. 7.

It should be apparent that the above-description enables the workload management task of the workload management system 120 to run autonomously (i.e., all by itself or “driverless”). The autonomously-running workload management system 120 should take all the data management decisions to provide the optimal performance for user's workloads. The autonomously-running workload management system 120 is able to predict the future load for each workload group. With the knowledge of what is going to happen in future, an autonomous database can choose proper optimization strategies at the right time. Thus, the autonomously-running workload management system 120 is a proactive approach to workload management. This proactive approach is opposite to the current known reactive approach in which a DBA sets resource allocation for workloads based on historical observations of the load pattern for the workloads. The reactive approach of the DBA's process is mostly heuristic-driven in nature, and multiple trial and errors are required before the DBA can identify an ideal resource share allocation for workloads.

A number of advantages result by providing an autonomous database. One advantage is that the system capacity can be dynamically scaled up or scaled down. Depending on the expected load, the autonomous workload management system 120 can scale the database up or down to meet the performance goals of the workloads. This capability to dynamically scale up and down at right time for the right duration is important when the database is deployed in a cloud environment to make maximum value out of “pay-as-you-use” approach of the cloud service providers.

Another advantage is that resources to workload groups can be dynamically allocated. Depending on the arrival of queries in different workload groups, resources allocated to those workload groups can be tuned dynamically to maximize the number of queries meeting their SLG. In situations when there is resource constraint resulting in queries missing SLG, there is need to optimize resources in such a way that overall system performance is optimized. System performance can be defined as maximum queries meeting their SLGs weighted according to their priority. Also, setting of resource allocation is important so that the less priority workload groups do not get into starvation.

It should also be apparent that above-description describes a novel method by which workload parameters (such as CPU consumed, IO consumed, and query arrival rate) can be predicted by learning from history. Potential features are identified, and then the number of features are reduced to a more manageable number using PCA. The first two metrics (i.e., the CPU consumed and the IO consumed) are the core resources for a database system and can be controlled by the resource allocation value. To achieve optimal system performance by dynamically allocating resources, the query arrival rate is predicted.

It should further be apparent that the above description describes a method that facilitates performance enhancement of a database system which uses a SLG-driven workload management system. It is conceivable that the above-described method may be applied to facilitate performance enhancement of any type of database system.

Although the above description describes three metrics (i.e., CPU consumed, IO consumed, and query arrival rate) that are predicted to provide the above advantages, it is conceivable that any other metric (e.g., worker thread) can be predicted. Moreover, it is conceivable that any combination of metrics can be predicted for any particular workload management system.

Also, although the predictive apparatus 300 is shown in FIG. 1 as being separate from the workload management system 120 and the database system 130, it is conceivable that some portion or all of the predictive apparatus 300 may be disposed within either the working management system 120 or the database system 130.

Each of the above-described flowchart 500 of FIG. 5, flowchart 600 of FIG. 6, and flowchart 700 of FIG. 7 depicts process serialization to facilitate an understanding of disclosed embodiments and is not necessarily indicative of the serialization of the operations being performed. In various embodiments, the processing steps described in each of the flowcharts above may be performed in varying order, and one or more depicted steps may be performed in parallel with other steps. Additionally, execution of some processing steps of each of the flowcharts above may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer.

The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Although disclosed embodiments have been illustrated in the accompanying drawings and described in the foregoing description, it will be understood that embodiments are not limited to the disclosed examples, but are capable of numerous rearrangements, modifications, and substitutions without departing from the disclosed embodiments as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information.

Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols.

The text above described one or more specific embodiments of a broader invention. The invention also is carried out in a variety of alternative embodiments and thus is not limited to those described here. For example, while the invention has been described here in terms of a database system that uses a massively parallel processing (MPP) architecture, other types of database systems, including those that use a symmetric multiprocessing (SMP) architecture, are also useful in carrying out the invention. Many other embodiments are also within the scope of the following claims.

What is claimed is:

1. A method for predicting workload group metrics of a workload management system of a database system, the method comprising:
predicting a future workload group metric for a plurality of workload groups based upon historical user-load patterns, wherein each workload group has a priority that is different from priority of other workload groups.

2. A method according to claim 1, wherein predicting a future workload group metric for a plurality of workload groups based upon historical user-load patterns includes:
predicting (i) a future central processing unit (CPU) consumption for each workload group based upon historical user-load patterns, (ii) a future input/output (TO) consumption for each workload group based upon historical user-load patterns, and (iii) a future number of queries to arrive for each workload group based upon historical user-load patterns.

3. A method according to claim 2, wherein predicting a future workload group metric for a plurality of workload groups based upon historical user-load patterns includes:
predicting a future workload group metric for each workload group based upon an encoded historical time interval that is between 10 minutes and 180 minutes.

4. A method according to claim 1, wherein the method is performed by a processor having a memory executing one or more programs of instructions which are tangibly embodied in a program storage medium readable by the processor.

5. A workload management system having a workload management task that uses the method of claim 1.

6. A method for predicting workload group metrics of a workload management system of a database system, the method comprising:
extracting feature values associated with operation of the database system, wherein the feature values comprise at least one of central processing unit (CPU) consumption, input/output (IO) consumption, and query arrival rate;
reducing the number extracted feature values by removing correlated feature values and skewed feature values; and
predicting the workload group metrics based upon the reduced number of extracted feature values.

7. A method according to claim 6 further comprising:
normalizing each feature value by (i) calculating a mean value, (ii) scaling the mean value to a unit variance, and (iii) removing the mean value.

8. A method according to claim 7 further comprising:
selectively picking remaining feature values that cumulatively retain about 99 percent of variance.

9. A method according to claim 6 further comprising:
defining a single neural network model for each workload group.

10. A method according to claim 9 further comprising:
retraining one workload group based upon its corresponding single neural network model while other workload groups remain the same.

11. A method according to claim 10, wherein retraining one workload group based upon its corresponding single neural network model while other workload groups remain the same includes:
retraining the one workload group based upon a recurrent neural network model.

12. A method according to claim 11, wherein retraining the one workload group based upon a recurrent neural network includes:
retraining the one workload group based upon a long short term neural network model.

13. A method according to claim 12 further comprising:
building a neural network model based upon an auto-correlation function (ACF) to identify the amount history needed to predict a future feature value for a workload group.

14. A method according to claim 6, wherein the method is performed by a processor having a memory executing one or more programs of instructions which are tangibly embodied in a program storage medium readable by the processor.

15. A workload management system having a workload management task that uses the method of claim 6.

16. A method for operating a workload management system of a database system, the method comprising:
predicting a workload group metric value;
obtaining from query logs an actual value of the corresponding workload group metric value;
computing a difference between the predicted value and the actual value; and
performing at least one of alerting a user and initiating auto-training of a workload when the difference between the predicted value and the actual value is more than a threshold value.

17. A method according to claim 16, wherein the predicted workload group metric value comprises (i) a future central processing unit (CPU) consumption for each workload group based upon historical user-load patterns, (ii) a future input/output (IO) consumption for each workload group based upon historical user-load patterns, and (iii) a future number of queries to arrive for each workload group based upon historical user-load patterns.

18. A method according to claim 16, wherein the predicted workload group metric value comprises a future workload group metric for each workload group based upon an encoded historical time interval that is between 10 minutes and 180 minutes.

19. A method according to claim 16, wherein the method is performed by a processor having a memory executing one or more programs of instructions which are tangibly embodied in a program storage medium readable by the processor.

20. A workload management system having a workload management task that uses the method of claim 16.
